(19) United States
(12) Patent Application Publication
(10) Pub. No.: US 2026/0361662 A1
(43) Pub. Date: Nov. 12, 2026

(54) METHODS, DEVICES AND COMPUTER READABLE MEDIUM FOR PACKET DISCARD

(71) Applicant: NEC Corporation, Tokyo (JP)

(72) Inventor: Gang WANG, Beijing (CN)

(73) Assignee: NEC Corporation, Tokyo (JP)

(21) Appl. No.: 19/470,299

(22) PCT Filed: Mar. 31, 2023
(86) PCT No.: PCT/CN2023/085809

§ 371 Date: Sep. 29, 2025

(51) Int. Cl. H04L 47/32

(52) U.S. Cl. CPC H04L 47/32

(57) ABSTRACT

Embodiments of the present disclosure relate to devices, methods and computer readable media for packet discard. A terminal device obtains a strategy for performing importance-based packet discard. Based on determining that the importance-based packet discard is activated, the terminal device performs the importance-based packet discard. Based on determining that the importance-based packet discard is deactivated, the terminal device prevents from performing the importance-based packet discard, wherein the importance-based packet discard is performed based on the importance of the packet. As such, the terminal device may discard packets based on the importance of the packets. Thereby transmission latency is reduced and the performance of communications is improved.

### TECHNICAL FIELD

Embodiments of the present disclosure generally relate to the field of communication, and in particular, to methods, devices and a computer readable medium for packet discard.

### BACKGROUND

Currently, a study item for extended reality (XR) enhancement is ongoing. It has been discussed that XR-awareness by user equipment (UE) and gNB would improve user experience, improve new radio (NR) system capacity in supporting XR services, and reduce UE power consumption. Due to internet protocol (IP) segmentation or other reasons, a video frame in XR traffic may arrive at radio access network (RAN) as a group of packets, and the video frame may also be received from the application layer as a group of packets. Data burst may occur during XR traffic transmission. Packet discard is an effective way to mitigate the data burst. However, packet discard is still incomplete and needs to be further developed.

### SUMMARY

In general, example embodiments of the present disclosure provide methods, devices and a computer readable medium for packet discard.

In a first aspect, there is provided a method for communication. The method comprises: obtaining, at a terminal device, a strategy for performing importance-based packet discard; based on determining that the importance-based packet discard is activated, performing the importance-based packet discard; and based on determining that the importance-based packet discard is deactivated, preventing from performing the importance-based packet discard, wherein the importance-based packet discard is performed based on the importance of the packet.

In a second aspect, there is provided a method for communication. The method comprises: determining, at a network device, a strategy for a terminal device to perform importance-based packet discard; transmitting the strategy to the terminal device; based on determining that the importance-based packet discard is to be activated, transmitting, to the terminal device, an indication to activate the importance-based packet discard; and based on determining that the importance-based packet discard is to be deactivated, transmitting, to the terminal device, an indication to deactivate the importance-based packet discard, wherein the importance-based packet discard is performed based on importance of a packet.

In a third aspect, there is provided a terminal device. The terminal device comprises a processor; and a memory storing computer program codes; the memory and the computer program codes configured to, with the processor, cause the terminal device to perform the method according to the first aspect.

In a fourth aspect, there is provided a network device. The network device comprises a processor; and a memory storing computer program codes; the memory and the computer program codes configured to, with the processor, cause the network device to perform the method according to the second aspect.

In a fifth aspect, there is provided a computer readable medium having instructions stored thereon, the instructions, when executed by a processor of an apparatus, causing the apparatus to perform the method according to the first aspect or the second aspect.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIG. 1 illustrates an example network environment in which some embodiments of the present disclosure can be implemented;

FIG. 2 illustrates an example signaling chart illustrating an example process according to some embodiments of the present disclosure;

FIG. 3 illustrates example packet data convergence protocol (PDCP) control packet data unit (PDU) formats according to some embodiments of the present disclosure;

FIG. 4 illustrates example medium access control (MAC) control element (CE) formats according to some embodiments of the present disclosure;

FIG. 5 illustrates a flowchart of a method implemented at a terminal device according to some embodiments of the present disclosure;

FIG. 6 illustrates a flowchart of a method implemented at a network device according to some other embodiments of the present disclosure; and

FIG. 7 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitations as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “terminal device” refers to any device having wireless or wired communication capabilities. Examples of terminal device include, but not limited to, user equipment (UE), personal computers, desktops, mobile phones, cellular phones, smart phones, personal digital assistants (PDAs), portable computers, tablets, wearable devices, internet of things (IoT) devices, Ultra-reliable and Low Latency Communications (URLLC) devices, Internet of Everything (IoE) devices, machine type communication (MTC) devices, device on vehicle for V2X communication where X means pedestrian, vehicle, or infrastructure/network, devices for Integrated Access and Backhaul (IAB), Space borne vehicles or Air borne vehicles in Non-terrestrial networks (NTN) including Satellites and High Altitude Platforms (HAPs) encompassing Unmanned Aircraft Systems (UAS), eXtended Reality (XR) devices including different types of realities such as Augmented Reality (AR), Mixed Reality (MR) and Virtual Reality (VR), the unmanned aerial vehicle (UAV) commonly known as a drone which is an aircraft without any human pilot, devices on high speed train (HST), or image capture devices such as digital cameras, sensors, gaming devices, music storage and playback appliances, or Internet appliances enabling wireless or wired Internet access and browsing and the like. The ‘terminal device’ can further has ‘multicast/broadcast’ feature, to support public safety and mission critical, V2X applications, transparent IPv4/IPv6 multicast delivery, IPTV, smart TV, radio services, software delivery over wireless, group communications and IoT applications. It may also be incorporated one or multiple Subscriber Identity Module (SIM) as known as Multi-SIM. The term “terminal device” can be used interchangeably with a UE, a mobile station, a subscriber station, a mobile terminal, a user terminal or a wireless device.

As used herein, the term “network device” refers to a device which is capable of providing or hosting a cell or coverage where terminal devices can communicate. Examples of a network device include, but not limited to, a satellite, an unmanned aerial systems (UAS) platform, a Node B (NodeB or NB), an evolved NodeB (eNodeB or eNB), a next generation NodeB (gNB), a transmission reception point (TRP), a remote radio unit (RRU), a radio head (RH), a remote radio head (RRH), an IAB node, a low power node such as a femto node, a pico node, a reconfigurable intelligent surface (RIS), and the like.

Communications discussed herein may conform to any suitable standards including, but not limited to, New Radio Access (NR), Long Term Evolution (LTE), LTE-Evolution, LTE-Advanced (LTE-A), Wideband Code Division Multiple Access (WCDMA), Code Division Multiple Access (CDMA), cdma2000, and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.85G, the third generation (3G), the fourth generation (4G), 4.5G, the fifth generation (5G), and the sixth (6G) communication protocols. The techniques described herein may be used for the wireless networks and radio technologies mentioned above as well as other wireless networks and radio technologies. The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The terminal device or the network device may have Artificial intelligence (AI) or machine learning capability. It generally includes a model which has been trained from numerous collected data for a specific function, and can be used to predict some information.

The terminal device or the network device may work on several frequency ranges, e.g. FR1 (410 MHz-7125 MHz), FR2 (24.25 GHz to 71 GHz), frequency band larger than 100 GHz as well as Tera Hertz (THz). It can further work on licensed/unlicensed/shared spectrum. The terminal device may have more than one connection with the network device under Multi-Radio Dual Connectivity (MR-DC) application scenario. The terminal device or the network device can work on full duplex, flexible duplex and cross division duplex modes.

The embodiments of the present disclosure may be performed in test equipment, e.g., signal generator, signal analyzer, spectrum analyzer, network analyzer, test terminal device, test network device, or channel emulator.

The embodiments of the present disclosure may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols, 5.5G, 5G-Advanced networks, or the sixth generation (6G) networks.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

As used herein, the term “PDU set” may refer to a group of PDU. A PDU Set is composed of one or more PDUs carrying the payload of one unit of information generated at the application level (e.g. a frame or video slice for XRM Services). In some implementations, all PDUs in a PDU set are needed by the application layer to use the corresponding unit of information. In other implementations, the application layer can still recover parts or all of the information unit, when some PDUs are missing.

As used herein, the term “data burst” may refer to service data units (SDU), PDUs, or a set of multiple PDUs generated and sent by the application in a short period of time. A data burst can be composed by one or multiple SDUs, PDUs, or PDU sets.

As mentioned above, due to IP segmentation or other reasons, a video frame in XR traffic may arrive at RAN as a set of PDU (e.g. multiple IP packets), and the video frame may also be received from the application layer as a set of PDU. For XR or media services, a group of packets is used to carry payloads of a PDU set (e.g. a frame, video slice or tile). Packets in such a PDU set may be decoded or handled as a whole. PDU set-based quality of service (QoS) handling is studied and it would impact the design of RAN protocol. In current 5th generation system (5GS), the QoS flow is the finest granularity of QoS differentiation in the PDU session. The processing of each data packet in the QoS flow is relatively independent. Therefore, packet processing with PDU set granularity is not supported. As an example of packet, importance of the PDU set is provided by core network (CN) to identify the importance of a PDU set within a QoS flow in downlink. RAN may use it for PDU set level packet discarding in presence of congestion. Similarly, in uplink, PDU set importance should also be provided to the access layer.

Data burst may occur during data transmission in the above scenario. Packet discard is an effective way to mitigate the data burst. Various aspects of schemes related to the packet discard need to be further studied and improved. For example, it is still unclear how to perform importance-based packet. The discard order and the discard number need to be determined. It is also unclear how to trigger importance-based packet. In order to solve above problems, example embodiments of the present disclosure provide some solutions for packet discard.

According to embodiments of the present disclosure, the terminal device obtains a strategy for performing importance-based packet discard. Based on determining that the importance-based packet discard is activated, the terminal device performs the importance-based packet discard. Based on determining that the importance-based packet discard is deactivated, the terminal device prevents from performing the importance-based packet discard, wherein the importance-based packet discard is performed based on the importance of the packet. As such, the transmission latency is reduced and the performance of communications is improved.

Principles and some example embodiments of the present disclosure will be described in detail below with reference to the figures.

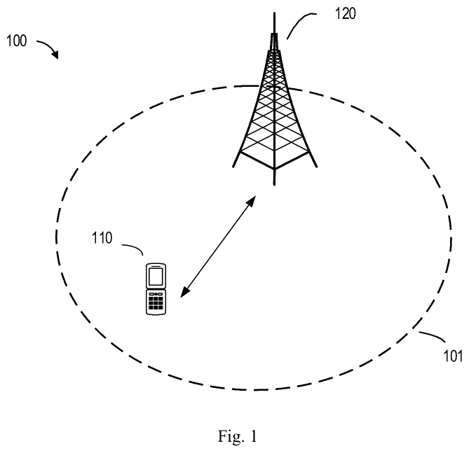

FIG. 1 illustrates an example network environment 100 in which example embodiments of the present disclosure may be implemented. The environment 100, which may be a part of a communication network, comprises terminal devices and network devices.

As illustrated in FIG. 1, the communication network 100 may comprise a terminal device 110 (hereinafter may also be referred to as user equipment 110 or a UE 110). The communication network 100 may further comprise a network device 120. The network device 120 may manage a cell 101. The terminal device 110 and the network device 120 may communicate data and control information to each other in the coverage of the cell. A link from the network device 120 to the terminal device 110 is referred to as a downlink (DL), while a link from the terminal device 110 to the network device 120 is referred to as an uplink (UL).

It is to be understood that the number of network devices and terminal devices is only for the purpose of illustration without suggesting any limitations. The system 100 may include any suitable number of network devices and terminal devices adapted for implementing embodiments of the present disclosure. Although not shown, it would be appreciated that one or more terminal devices may be located in the environment 100.

The communications in the communication network 100 may conform to any suitable standards including, but not limited to, Global System for Mobile Communications (GSM), LTE, LTE-Evolution, LTE-Advanced (LTE-A), Wideband Code Division Multiple Access (WCDMA), Code Division Multiple Access (CDMA), GSM EDGE Radio Access Network (GERAN), Machine Type Communication (MTC) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G) communication protocols.

In some embodiments, the terminal device 110 may perform packet discard so that congestion may be avoided and transmission latency is reduced. In some embodiments, the packet discard may be triggered by the network device 120 or the terminal device 110 itself. However, implementation of the packet discard is still incomplete.

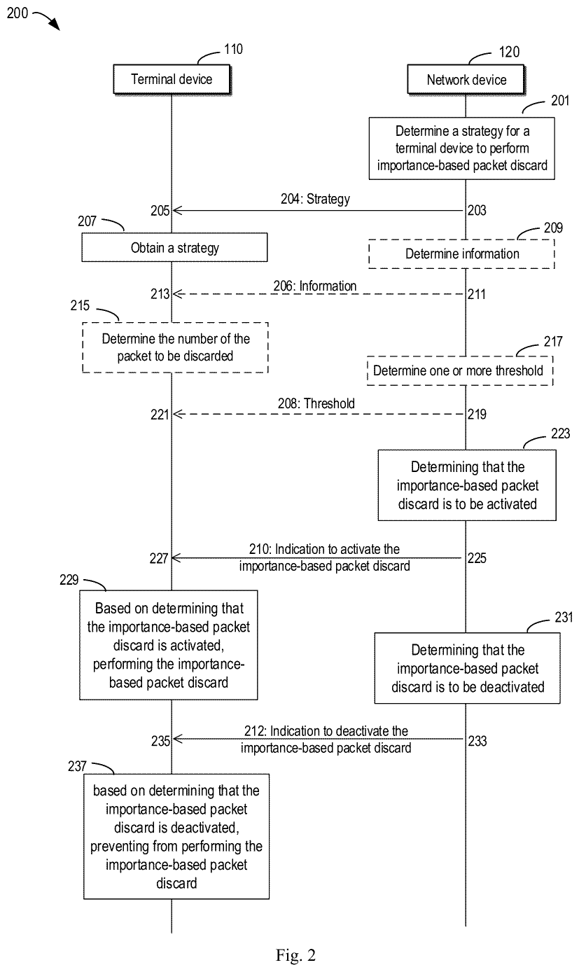

In view of this, embodiments of the present disclosure provide a solution of packet discard to overcome the above and other potential issues. The solution will be described in detail with reference to FIGS. 2-7 below.

FIG. 2 illustrates an example signaling chart illustrating an example process 200 according to some embodiments of the present disclosure. For the purpose of discussion, the example 200 will be described with reference to FIG. 1. The process 200 may involve the terminal device 110 and the network devices 120 as illustrated in FIG. 1.

In the example process 200, a network device 120 determines 201 a strategy for a terminal device 110 to perform importance-based packet discard. It is to be understood that the importance-based packet discard is performed based on the importance of a packet. Then the network device 120 transmits the strategy 204 to the terminal device 110. In some embodiments, the terminal device 110 may receive 205 the strategy 204 from the network device 120. In some embodiments, the strategy may be predefined, and the terminal device 110 may obtain the strategy from predefined information about the strategy. In other words, the terminal device 110 may obtain the strategy without receiving the strategy from the network device 120, and the network device 120 does not need to determine the strategy.

In some embodiments, the packet may comprise a SDU, a PDU, a PDU set, or any combination of two or more of the above-mentioned items. In some embodiments, the importance of the packet may comprise priority of the packet.

In some embodiments, the strategy may comprise a packet with lower importance is discarded prior to discarding a packet with higher importance. For example, if importance-based packet discard is enabled or activated, the SDU, PDU, or PDU set with less importance may be discarded first.

In some embodiments, the strategy may comprise a first packet among a plurality of packets with same importance is discarded prior to discarding a second packet among the plurality of packets obtained after the first packet. For example, if the SDUs, PDUs, PDU sets with the same importance, the SDU, PDU, or PDU set that arrives first may be discarded first.

In some embodiments, the strategy may comprise SDUs or PDUs belonging to a PDU set are discarded as a whole if the SDUs or PDUs are needed for usage of the PDU set. For example, in the event that a PDU set integrated indication is set to true or 1, which indicates that all SDUs or PDUs are needed for the usage of PDU set by application layer, then all SDUs or all PDUs belonging to the same PDU set may be discarded as a whole.

It is to be understood that any combination of two or more of the above-mentioned items may be comprised in the strategy.

Continuing with reference to FIG. 2, on the other side of the communication, the terminal device 110 obtains 207 a strategy for performing importance-based packet discard. For example, the terminal device 110 may obtain strategy from predefined information about the strategy or the network device 120.

In some embodiments, the network device 120 may determine 209 information for the terminal device 110 to determine a number of the packet to be discarded based on the strategy 204 and the importance of the packet. Then the network device 120 may transmit 211 the information 206 to the terminal device 110.

In some embodiments, the information 206 may comprise a ratio of a number of packets to be discarded to a total number of packets. For example, in order to assist UE to determine the number of SDUs, PDUs, or PDU sets that should be discarded, the network device may configure or indicate the ratio of the number of SDUs, PDUs or PDU sets to be discarded to the total number of SDUs, PDUs or PDU sets. In some embodiments, the information 206 may comprise a ratio of a size of packets to be discarded to a total size of packets. In some embodiments, the information 206 may comprise a total number of packets to be discarded. In some embodiments, the information 206 may comprise a total size of packets to be discarded. It is to be understood that the above-mentioned items may be related to per UE, per data radio bearer (DRB), or per QoS flow. It is also to be understood that any combination of two or more of the above-mentioned items may be comprised in the information.

Alternatively, a ratio table or ratio list of discarded SDUs, PDUs or PDU sets may be configured or defined. Each entry of the ratio table or the ratio list corresponds to a different congestion level. The network device 120 may indicate the ratio index to the terminal device 110.

In some embodiments, after receiving 213 the information 206 from the network device 120, the terminal device 110 may determine 215 the number of the packet to be discarded based on the information.

In some embodiments, the packets with an importance level may be are indicated or determined to be discarded, and in discarding the at least one packet, the terminal device 110 may discard all packets with the importance level. For example, if an importance level is indicated or determined to be discarded, then all SDUs, PDUs, or PDU sets with the importance level may be discarded. In some embodiments, in discarding the at least one packet, the terminal device 110 may also discard part of the packets with the importance level until the number of packets to be discarded is reached. For example, when the number of packets to be discarded or the ratio of the packets meets a ratio or a number indicated in the information 206, the terminal device 110 may stop performing importance-based packet discard according to the strategy mentioned above. In this way, SDUs, PDUs, PDU sets with a certain importance may not be completely discarded and the accuracy of the strategy is improved. It is to be understood that any combination of two or more of the above-mentioned items may be used to discard the packets.

In some embodiments, the network device 120 may determine 217 one or more threshold for the terminal device 110 to activate or deactivate the importance-based packet discard. The one or more threshold corresponds to one or more discard rates of packets at the terminal device and one or more congestion levels respectively. The network device 120 may transmit 219 the one or more threshold 208 to the terminal device 110. Accordingly, the terminal device 110 may receive 221 the one or more threshold 208 via one or more radio resource control (RRC) message.

Continuing with reference to FIG. 2, based on determining 223 that the importance-based packet discard is to be activated, the network device 120 transmits 225 an indication to activate the importance-based packet discard 210 to the terminal device 110. The importance-based packet discard is performed based on the importance of the packet. Accordingly, the terminal device 110 may receive 227 the indication 210. For example, the network device may judge whether congestion happens. If the congestion happens, the network device may indicate the UE to perform packet discard based on the importance of the packet.

In the event that the importance-based packet discard is activated, the terminal device 110 performs 229 the importance-based packet discard.

In some embodiments, in determining that the importance-based packet discard is activated, the terminal device 110 may receive an indication to activate the importance-based packet discard from a network device. In some embodiments, in determining that the importance-based packet discard is activated, the terminal device 110 may determine that a discard rate of packets at the terminal device is above a threshold received from the network device. For example, the terminal device 110 may count the discard rate (e.g., R_discard) of packets that is discarded due to discardTimer expires. The terminal device 110 may receive a threshold (e.g., T), and the threshold may be configured by the network device. Then the terminal device 110 may activate importance-based packet discard when R_discard is greater than T. It is to be understood that any combination of two or more of the above-mentioned items may determine that the importance-based packet discard is activated.

In some embodiments, the threshold may be one of a plurality of thresholds received from the network device 120, and the plurality of thresholds may correspond to a plurality of congestion levels and a plurality of discard rates respectively.

Based on determining 231 that the importance-based packet discard is to be deactivated, the network device 120 transmits 233 an indication to deactivate the importance-based packet discard 212 to the terminal device 110. Accordingly, the terminal device 110 may receive 235 the indication 212 from the network device 120.

Based on determining that the importance-based packet discard is deactivated, the terminal device 110 prevents 237 from performing the importance-based packet discard.

In some embodiments, in determining that the importance-based packet discard is deactivated, the terminal device 110 may receive an indication to deactivate the importance-based packet discard from a network device. In some embodiments, in determining that the importance-based packet discard is activated, the terminal device 110 may also determine that a discard rate of packets at the terminal device is equal to or below a threshold received from the network device. For example, the terminal device 110 may count the discard rate (e.g., R_discard) of packets that is discarded due to discardTimer expires. The terminal device 110 may receive a threshold (e.g., T), and the threshold may be configured by the network device. Then the terminal device 110 may deactivate importance-based packet discard when R_discard is equal to or below T. It is to be understood that any combination of two or more of the above-mentioned items may determine that the importance-based packet discard is deactivated.

In some embodiments, the indication 210 and the indication 212 may be transmitted via a PDCP control PDU, a MAC CE, downlink control information (DCI), a service data adaptation protocol (SDAP) control PDU, an RRC signaling, or any combination of two or more of the above-mentioned items.

In some embodiments, the indication 210 and the indication 212 may comprise a subfield indicative of importance of the at least one packet to be discarded. SDUs, PDUs, or PDU sets with less importance than the importance indicated by the field may be discarded. For example, if 4 importance levels (0~3) are defined, and 0 is the highest importance and 3 is the lowest importance. If the field value is 2, then SDUs, PDUs, or PDU sets with importance values 2 and 3 shall be discarded.

In some embodiments, the indication 210 and the indication 212 may comprise a subfield indicative of a ratio of packets to be discarded. For example, the subfield may indicate the ratio of the number of SDUs, PDUs, or PDU sets to be discarded to the total number of SDUs, PDUs, or PDU sets, the subfield may also indicate the ratio of the size of SDUs, PDUs, or PDU sets to be discarded to the total size of SDUs, PDUs, or PDU sets. In some embodiments, the indication 210 and the indication 212 may comprise a subfield indicative of a number or a size of packets to be discarded.

In some embodiments, the indication 210 and the indication 212 may comprise a subfield indicative of at least one identity of at least one quality of service (QoS) for which the importance-based packet discard is activated or deactivated.

It is to be understood that any combination of two or more of the above-mentioned items may be comprised the indication 210 and the indication 212.

In some embodiments, the indication 210 and the indication 212 may be received via a PDCP control PDU, and the indication 210 and the indication 212 may further comprise a subfield indicative of a type of a PDU, a subfield indicative of activating or deactivating the importance-based packet discard or any combination of two or more of the above-mentioned items.

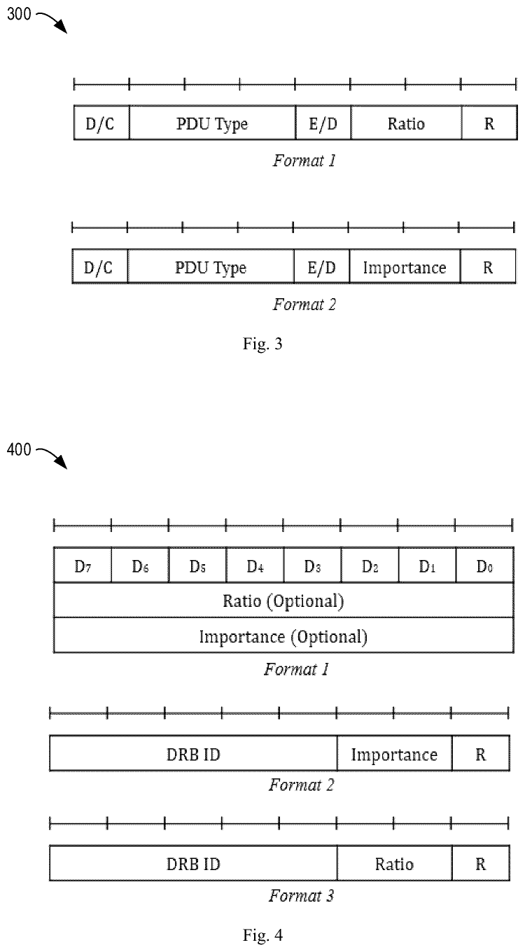

For example, the network device may indicate the terminal device 100 to activate or deactivate importance-based packet discard via a PDCP control PDU. FIG. 3 illustrates example PDCP control PDU formats 300 according to some embodiments of the present disclosure. As shown in FIG. 3, there are format 1 and format 2. The format 1 and format 2 of the PDCP control PDU may include at least one of the following: a new PDU type field, a E/D field indicating whether to enable or disable importance-based packet discard, Importance field, a field (e.g., Ratio) indicating the ratio (or ratio index) of SDUs, PDUs, or PDU sets to be discarded, a field indicating the number or size of SDUs, PDUs, or PDU sets to be discarded, or any combination of two or more of the above-mentioned items.

The PDU type descriptions for the defined bits are shown in the following table 3. For example, the new PDU type field may set to bit value “100”.

TABLE 3
PDU type

| Bit | Description |
|---|---|
| 000 | PDU status report |
| 001 | Interspersed ROHC feedback |
| 010 | Ethernet header compression (EHC)feedback |
| 011 | Uplink data compression (UDC) feedback |
| 100 | Importance-based packet discard activation/deactivation |
| 101-111 | Reserved |

In some embodiments, the indication 210 and the indication 212 may be received via a MAC CE, and the indication may further comprise a subfield indicative of at least one identity of at least one DRB for which the importance-based packet discard is activated or deactivated, a subfield indicative of an activation or deactivation status of the at least one DRB configured with the importance-based packet discard or any combination of two or more of the above-mentioned items.

For example, the network device may indicate the UE to activate or deactivate importance-based packet discard via a new MAC CE. FIG. 4 illustrates example MAC CE formats 400 according to some embodiments of the present disclosure. As shown in FIG. 4, there are format 1, format 2 and format 3. The format 1, format 2 and format 3 of the MAC CE may include at least one of the following fields: Di, DRB ID, Importance, or Ratio. In the format 1, the Importance field, or Ratio field may be optional.

DRB ID indicates the identity of DRB for which importance-based packet discard is activated or deactivated. Di indicates the activation or deactivation status of the importance-based packet discard of DRB i, and i is the ascending order of the DRB ID among the DRBs configured with importance-based packet discard. The Di field is set to 1 to indicate that the importance-based packet discard of DRB i shall be activated. The Di field is set to 0 to indicate that the importance-based packet discard of DRB i shall be deactivated.

In some embodiments, the indication 210 and the indication 212 may be received via DCI, and the indication 210 and the indication 212 may further comprise a subfield indicative of activating or deactivating the importance-based packet discard.

For example, the network device may indicate the terminal device to activate or deactivate importance-based packet discard via DCI in physical downlink control channel (PDCCH). A new field indicating to activate or deactivate importance-based packet discard is further introduced in the DCI. If the new field is set to 1, the terminal device may activate importance-based packet discard. If the new field is set to 0, the terminal device may deactivate importance-based packet discard.

In some embodiments, the indication 210 and the indication 212 may be received via a SDAP control PDU. The indication 210 and the indication 212 may further comprise a subfield indicative of a type of a PDU, a subfield indicative of activating or deactivating the importance-based packet discard, a subfield indicative of at least one identity of at least one quality of service (QoS) for which the importance-based packet discard is activated or deactivated, or any combination of two or more of the above-mentioned items.

For example, the network device 120 may indicate the terminal device 110 to activate or deactivate importance-based packet discard via a SDAP control PDU. Anew PDU type field indicating the type of SDAP control PDU may further be introduced.

In some embodiments, the indication 210 and the indication 212 may be further received via an RRC message. The indication 210 and the indication 212 may comprise a subfield indicative of a ratio of packets to be discarded, a subfield indicative of activating or deactivating the importance-based packet discard, a subfield indicative of a ratio list of packets to be discarded, a subfield indicative of at least one identity of at least one QoS for which the importance-based packet discard is activated or deactivated, or any combination of two or more of the above-mentioned items.

For example, the network device configures the UE to enable or disable importance-based packet discard via an RRC message. The RRC message may be configured as below:
PDCP-Config::=SEQUENCE {
   importanceBasedDiscard ENUMERATED {enabled}//If importanceBasedDiscard is set to “enabled”, UE shall perform importance-based packet (e.g., SDU/PDU/PDU Set) discard. Otherwise, UE shall not perform importance-based packet discard.
   ratio ENUMERATED {0, 0.05, 0.1, 0.2, 0.3, 0.4, 0.5, . . . , 1}// The ratio of the number of SDU/PDU or PDU Set to be discarded to the total number of SDU/PDU/PDU Set, or the ratio of the size of SDUs/PDUs or PDU Sets to be discarded to the total size of SDUs/PDUs/PDU Sets.
   ratioList SetupRelease {DiscardRatioList}//The ratio list of the number of SDU/PDU or PDU Set to be discarded to the total number of SDU/PDU/PDU Set, or the ratio list of the size of SDUs/PDUs or PDU Sets to be discarded to the total size of SDUs/PDUs/PDU Sets.
}
DiscardRatioList::=SEQUENCE (SIZE (1..maxRatio)) OF DiscardRatio
DiscardRatio::=ENUMERATED {0, 0.05, 0.1, 0.2, 0.3, 0.4, 0.5, . . . , 1}

In some embodiments, the discard rate may comprise a ratio of a number of packets are discarded due to a discard timer expires to a total number of packets. In some embodiments, the discard rate may also comprise a ratio of a size of packets are discarded due to a discard timer expires to a total size of packets. It is to be understood that combination of two of the above-mentioned items may be comprised in the discard rate.

In MAC layer, the procedure of importance-based packet discard may be as follows: if a terminal device is configured with importance-based packet discard, and/or a MAC CE indicating activation or deactivation of importance-based packet discard has been received, the terminal device may indicate upper layer (e.g., PDCP/SDAP layer) to activate or deactivate the importance-based packet discard, and deliver the necessary information to upper layer. The necessary information may comprise at least one of importance information or ratio information for the importance-based packet discard.

In physical (PHY) layer, the procedure of importance-based packet discard may be as follows: if a terminal device is configured with importance-based packet discard, and/or a DCI indicating activation or deactivation of importance-based packet discard has been received, the terminal device may indicate upper layer (e.g., PDCP/SDAP layer) to activate or deactivate the importance-based packet discard, and deliver the necessary information to upper layer. The necessary information may comprise at least one of importance information or ratio information for the importance-based packet discard.

In PDCP layer, the procedure of importance-based packet discard may be as follows: in the event that the indication of activation of importance-based packet discard has been received from lower layer (MAC or PHY layer), or a PDCP control PDU indicates activation of importance-based packet has been received, a PDCP entity may activate or perform the importance-based packet discard. In the event that the indication of deactivation of importance-based packet discard has been received from lower layer (MAC or PHY layer), or a PDCP control PDU indicates deactivation of importance-based packet discard has been received, the PDCP entity may deactivate the importance-based packet discard.

As describe above, the key idea to solve the problem is importance-based packet discard and trigger condition (activate and deactivate). The importance-based packet discard relates to discard strategy and the number of packets should be discarded. The trigger condition comprises network triggered and UE triggered.

In general, packets with lower importance are discarded first when trigger conditions are met. If importance-based packet discard is performed, lower importance packet shall be discarded first. In addition, the packet that arrives first is discarded first. The discard ratio or discard number is configured by the network device.

In this way, transmission latency is reduced and the performance of communications is improved.

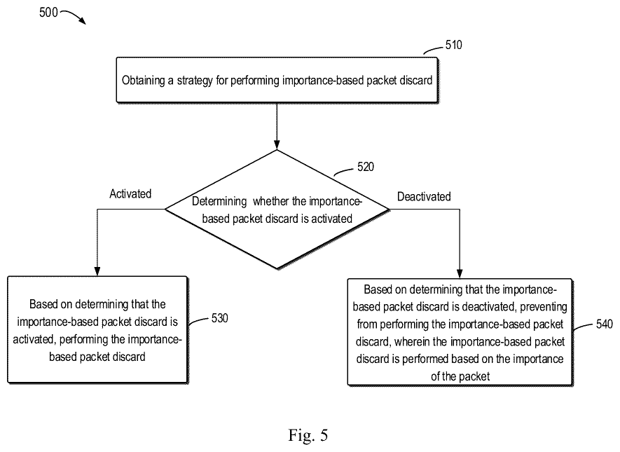

FIG. 5 illustrates a flowchart of a method implemented at a terminal device according to some embodiments of the present disclosure. In some embodiments, the method 500 can be implemented at a communication device, such as the terminal device 110 as shown in FIG. 1. For the purpose of discussion, the method 500 will be described with reference to FIG. 1 as performed by the terminal device 110 without loss of generality.

At block 510, the terminal device 110 obtains a strategy for performing importance-based packet discard. At block 520, the terminal device 110 determines whether the importance-based packet discard is activated. At block 530, the terminal device 110 performs the importance-based packet discard based on determining that the importance-based packet discard is activated. At block 540, the terminal device 110 prevents from performing the importance-based packet discard based on determining that the importance-based packet discard is deactivated, wherein the importance-based packet discard is performed based on the importance of the packet.

In some embodiments, the packet may comprise a service data unit (SDU), a packet data unit (PDU); a PDU set, or any combination of two or more of the above-mentioned items.

In some embodiments, the strategy may comprise a packet with lower importance is discarded prior to discarding a packet with higher importance, a first packet among a plurality of packets with same importance is discarded prior to discarding a second packet among the plurality of packets obtained after the first packet, SDUs or PDUs belonging to a PDU set are discarded as a whole in the case that the SDUs, or PDUs are needed for usage of the PDU set or any combination of two or more of the above-mentioned items.

In some embodiments, the terminal device 110 may further receive, information for the terminal device to determine a number of packet to be discarded from a network device. Then the terminal device 110 may determine the number of the packet to be discarded based on the information.

In some embodiments, the information may comprise a ratio of a number of packets to be discarded to a total number of packets, a ratio of a size of packets to be discarded to a total size of packets, a total number of packets to be discarded, a total size of packets to be discarded, or any combination of two or more of the above-mentioned items.

In some embodiments, the packets with an importance level may be indicated or determined to be discarded. In order to discard the at least one packet, the terminal device 110 may discard all packets with the importance level, discard part of the packets with the importance level until the number of packets to be discarded is reached, or any combination of two or more of the above-mentioned items.

In some embodiments, in order to determine that the importance-based packet discard is activated, the terminal device 110 may receive an indication to activate the importance-based packet discard from a network device, determine that a discard rate of packets at the terminal device is above a threshold received from the network device or any combination of two or more of the above-mentioned items.

In some embodiments, in determining that the importance-based packet discard is deactivated, the terminal device 110 may receive an indication to deactivate the importance-based packet discard from a network device, determine that a discard rate of packets at the terminal device is equal to or below a threshold received from the network device or any combination of two or more of the above-mentioned items.

In some embodiments, the threshold may be received via a radio resource control (RRC) message, and the indication may be received via a packet data convergence protocol (PDCP) control PDU, a medium access control (MAC) control element (CE), downlink control information (DCI), a service data adaptation protocol (SDAP) control PDU, an RRC signaling, or any combination of two or more of the above-mentioned items.

In some embodiments, the indication may comprise a subfield indicative of importance of the at least one packet to be discarded, a subfield indicative of a ratio of packets to be discarded, a subfield indicative of a number or a size of packets to be discarded, a subfield indicative of at least one identity of at least one quality of service (QoS) for which the importance-based packet discard is activated or deactivated, or any combination of two or more of the above-mentioned items.

In some embodiments, the indication may be received via a PDCP control PDU, and the indication may further comprise a subfield indicative of a type of a PDU, a subfield indicative of activating or deactivating the importance-based packet discard, or any combination of two or more of the above-mentioned items.

In some embodiments, the indication may be received via a MAC CE, and the indication may further comprise a subfield indicative of at least one identity of at least one data radio bearer (DRB) for which the importance-based packet discard is activated or deactivated, a subfield indicative of an activation or deactivation status of the at least one DRB configured with the importance-based packet discard, or any combination of two or more of the above-mentioned items.

In some embodiments, the indication may be received via DCI, and the indication may further comprise a subfield indicative of activating or deactivating the importance-based packet discard.

In some embodiments, the indication may be received via a SDAP control PDU, and the indication may further comprise a subfield indicative of a type of a PDU, a subfield indicative of activating or deactivating the importance-based packet discard, a subfield indicative of at least one identity of at least one quality of service (QoS) for which the importance-based packet discard is activated or deactivated, or any combination of two or more of the above-mentioned items.

In some embodiments, the indication may be further received via an RRC message, and the indication may comprise a subfield indicative of a ratio of packets to be discarded, a subfield indicative of activating or deactivating the importance-based packet discard, a subfield indicative of a ratio list of packets to be discarded, a subfield indicative of at least one identity of at least one quality of service (QoS) for which the importance-based packet discard is activated or deactivated, or any combination of two or more of the above-mentioned items.

In some embodiments, the discard rate may comprise a ratio of a number of packets are discarded due to a discard timer expires to a total number of packets, a ratio of a size of packets are discarded due to a discard timer expires to a total size of packets, or any combination of two or more of the above-mentioned items.

In some embodiments, the threshold may be one of a plurality of thresholds received from the network device, and the plurality of thresholds may correspond to a plurality of congestion levels and a plurality of discard rates respectively. In some embodiments, the importance of the packet may comprise priority of the packet.

With the method of FIG. 5, transmission latency is reduced and the performance of communications is improved.

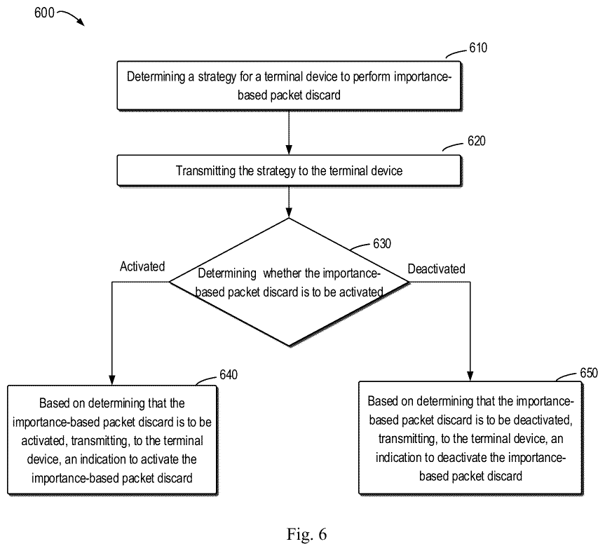

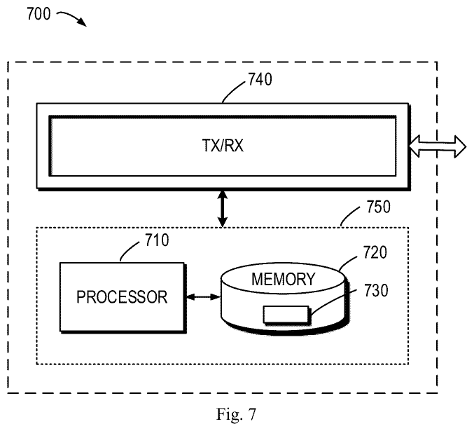

FIG. 6 illustrates a flowchart of a method implemented at a network device according to some embodiments of the present disclosure. In some embodiments, the method 600 can be implemented at a communication device, such as the network device 120 as shown in FIG. 1. For the purpose of discussion, the method 600 will be described with reference to FIG. 1 as performed by the network device 120 without loss of generality.

At block 610, the network device 120 determines a strategy for a terminal device to perform importance-based packet discard. At block 620, the network device 120 transmits the strategy to the terminal device. At block 630, the network device 120 determines whether the importance-based packet discard is to be activated. At block 640, the network device 120 transmits an indication to activate the importance-based packet discard to the terminal device, based on determining that the importance-based packet discard is to be activated. At block 650, the network device 120 transmits an indication to deactivate the importance-based packet discard to the terminal device, based on determining that the importance-based packet discard is to be deactivated, wherein the importance-based packet discard is performed based on the importance of the packet.

In some embodiments, the packet may comprise a service data unit (SDU), a packet data unit (PDU); a PDU set, or any combination of two or more of the above-mentioned items.

In some embodiments, the strategy may comprise a packet with lower importance is discarded prior to discarding a packet with higher importance, a first packet among a plurality of packets with same importance is discarded prior to discarding a second packet among the plurality of packets obtained after the first packet, SDUs or PDUs belonging to a PDU set are discarded as a whole in the case that the SDUs, or PDUs are needed for usage of the PDU set or any combination of two or more of the above-mentioned items.

In some embodiments, the network device 120 may further determine information for the terminal device to determine a number of the packet to be discarded. Then the network device 120 may transmit the information to the terminal device.

In some embodiments, the information may comprise a ratio of a number of packets to be discarded to a total number of packets, a ratio of a size of packets to be discarded to a total size of packets, a total number of packets to be discarded, a total size of packets to be discarded, or any combination of two or more of the above-mentioned items.

In some embodiments, the network device 120 may further determine one or more threshold for the terminal device to activate or deactivate the importance-based packet discard. The one or more threshold corresponds to one or more discard rates of packets at the terminal device and one or more congestion levels respectively. Then the network device 120 may transmit one or more threshold to the terminal device.

In some embodiments, the threshold may be transmitted via a radio resource control (RRC) message, and the indication may be transmitted via a radio resource control (RRC) message, a packet data convergence protocol (PDCP) control PDU, a medium access control (MAC) control element (CE), downlink control information (DCI), a service data adaptation protocol (SDAP) control PDU, or any combination of two or more of the above-mentioned items. In some embodiments, the importance of the packet may comprise priority of the packet.

With the method of FIG. 6, transmission latency is reduced and the performance of communications is improved.

FIG. 7 illustrates a simplified block diagram of a device 700 that is suitable for implementing embodiments of the present disclosure. The device 700 can be considered as a further example implementation of the terminal device 110 and/or the network device 120 as shown in FIG. 1. Accordingly, the device 700 can be implemented at or as at least a part of the terminal device 110 or the network device 120.

As shown, the device 700 includes a processor 710, a memory 720 coupled to the processor 710, a suitable transmitter (TX) and receiver (RX) 740 coupled to the processor 710, and a communication interface coupled to the TX/RX 740. The memory 710 stores at least a part of a program 730. The TX/RX 740 is for bidirectional communications. The TX/RX 740 has at least one antenna to facilitate communication, though in practice an access node mentioned in this disclosure may have several ones. The communication interface may represent any interface that is necessary for communication with other network elements, such as X2 interface for bidirectional communications between eNBs or gNBs, S1 interface for communication between a Mobility Management Entity (MME)/Serving Gateway (S-GW) and the eNB or gNB, Un interface for communication between the eNB or gNB and a relay node (RN), or Uu interface for communication between the eNB or gNB and a terminal device.

The program 730 is assumed to include program instructions that, when executed by the associated processor 710, enable the device 700 to operate in accordance with the embodiments of the present disclosure, as discussed herein with reference to FIGS. 1-6. The embodiments herein may be implemented by computer software executable by the processor 710 of the device 700, or by hardware, or by a combination of software and hardware. The processor 710 may be configured to implement various embodiments of the present disclosure. Furthermore, a combination of the processor 710 and memory 720 may form processing means 750 adapted to implement various embodiments of the present disclosure.

The memory 720 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 720 is shown in the device 700, there may be several physically distinct memory modules in the device 700. The processor 710 may be of any type suitable to the local technical network, and may include one or more of general purpose computers, special purpose computers, microprocessors, digital signal processors (DSPs) and processors based on multicore processor architecture, as non-limiting examples. The device 700 may have multiple processors, such as an application specific integrated circuit chip that is slaved in time to a clock which synchronizes the main processor.

In summary, embodiments of the present disclosure may provide the following solutions.

A method for communication comprises obtaining, at a terminal device, a strategy for performing importance-based packet discard; based on determining that the importance-based packet discard is activated, performing the importance-based packet discard; and based on determining that the importance-based packet discard is deactivated, preventing from performing the importance-based packet discard, wherein the importance-based packet discard is performed based on the importance of the packet.

In one embodiment, the packet comprises at least one of the following: a service data unit (SDU); a packet data unit (PDU); or a PDU set.

In one embodiment, the strategy comprises at least one of the following: a packet with lower importance is discarded prior to discarding a packet with higher importance; a first packet among a plurality of packets with same importance is discarded prior to discarding a second packet among the plurality of packets obtained after the first packet; or SDUs or PDUs belonging to a PDU set are discarded as a whole in the case that the SDUs or PDUs are needed for usage of the PDU set.

In one embodiment, the method further comprises receiving, from a network device, information for the terminal device to determine a number of packet to be discarded; and determining, based on the information, the number of the packet to be discarded.

In one embodiment, the information comprises at least one of the following: a ratio of a number of packets to be discarded to a total number of packets; a ratio of a size of packets to be discarded to a total size of packets; a total number of packets to be discarded; or a total size of packets to be discarded.

In one embodiment, the packets with an importance level are indicated or determined to be discarded, and discarding the at least one packet comprises at least one of the following: discarding all packets with the importance level; or discarding part of the packets with the importance level until the number of packets to be discarded is reached.

In one embodiment, determining that the importance-based packet discard is activated comprises at least one of the following: receiving, from a network device, an indication to activate the importance-based packet discard; or determining that a discard rate of packets at the terminal device is above a threshold received from the network device.

In one embodiment, determining that the importance-based packet discard is deactivated comprises at least one of the following: receiving, from a network device, an indication to deactivate the importance-based packet discard; or determining that a discard rate of packets at the terminal device is equal to or below a threshold received from the network device.

In one embodiment, the threshold is received via a radio resource control (RRC) message, and wherein the indication is received via at least one of the following: a packet data convergence protocol (PDCP) control PDU; a medium access control (MAC) control element (CE); downlink control information (DCI); or a service data adaptation protocol (SDAP) control PDU.

In one embodiment, the indication comprises at least one of the following: a subfield indicative of importance of the at least one packet to be discarded; a subfield indicative of a ratio of packets to be discarded; a subfield indicative of a number or a size of packets to be discarded; or a subfield indicative of at least one identity of at least one quality of service (QoS) for which the importance-based packet discard is activated or deactivated.

In one embodiment, the indication is received via a PDCP control PDU, and the indication further comprises at least one of the following: a subfield indicative of a type of a PDU; or a subfield indicative of activating or deactivating the importance-based packet discard.

In one embodiment, the indication is received via a MAC CE, and the indication further comprises at least one of the following: a subfield indicative of at least one identity of at least one data radio bearer (DRB) for which the importance-based packet discard is activated or deactivated; or a subfield indicative of an activation or deactivation status of the at least one DRB configured with the importance-based packet discard.

In one embodiment, the indication is received via DCI, and the indication further comprises a subfield indicative of activating or deactivating the importance-based packet discard.

In one embodiment, the indication is received via a SDAP control PDU, and the indication further comprises at least one of the following: a subfield indicative of a type of a PDU; a subfield indicative of activating or deactivating the importance-based packet discard; or a subfield indicative of at least one identity of at least one quality of service (QoS) for which the importance-based packet discard is activated or deactivated.

In one embodiment, the indication is further received via an RRC message, and the indication comprises at least one of the following: a subfield indicative of a ratio of packets to be discarded; a subfield indicative of activating or deactivating the importance-based packet discard; a subfield indicative of a ratio list of packets to be discarded; or a subfield indicative of at least one identity of at least one quality of service (QoS) for which the importance-based packet discard is activated or deactivated.

In one embodiment, the discard rate comprises at least one of the following: a ratio of a number of packets is discarded due to a discard timer expires to a total number of packets; a ratio of a size of packets are discarded due to a discard timer expires to a total size of packets.

In one embodiment, the threshold is one of a plurality of thresholds received from the network device, and the plurality of thresholds correspond to a plurality of congestion levels and a plurality of discard rates respectively.

In one embodiment, the importance of the packet comprises priority of the packet.

A method for communication comprises determining, at a network device, a strategy for a terminal device to perform importance-based packet discard; transmitting the strategy to the terminal device; based on determining that the importance-based packet discard is to be activated, transmitting, to the terminal device, an indication to activate the importance-based packet discard; and based on determining that the importance-based packet discard is to be deactivated, transmitting, to the terminal device, an indication to deactivate the importance-based packet discard, wherein the importance-based packet discard is performed based on the importance of the packet.

In one embodiment, the packet comprises at least one of the following: a service data unit (SDU); a packet data unit (PDU); or a PDU set.

In one embodiment, the strategy comprises at least one of the following: a packet with lower importance is discarded prior to discarding a packet with higher importance; a first packet among a plurality of packets with same importance is discarded prior to discarding a second packet among the plurality of packets obtained after the first packet; or SDU or PDUs belonging to a PDU set are discarded as a whole in the case that the SDUs or PDUs are needed for usage of the PDU set.

In one embodiment, the method further comprises: determining information for the terminal device to determine a number of the packet to be discarded; and transmitting, to the terminal device, the information.

In one embodiment, the information comprises at least one of the following: a ratio of a number of packets to be discarded to a total number of packets; a ratio of a size of packets to be discarded to a total size of packets; or a total number of packets to be discarded; a total size of packets to be discarded.

In one embodiment, the method further comprises determining one or more threshold for the terminal device to activate or deactivate the importance-based packet discard, wherein the one or more threshold corresponds to one or more discard rates of packets at the terminal device and one or more congestion levels respectively; and transmitting the one or more threshold to the terminal device.

In one embodiment, the threshold is transmitted via a radio resource control (RRC) message, and the indication is transmitted via at least one of the following: an RRC message; a packet data convergence protocol (PDCP) control PDU; a medium access control (MAC) control element (CE); downlink control information (DCI); a service data adaptation protocol (SDAP) control PDU.

In one embodiment, the importance of the packet comprises priority of the packet.

A terminal device comprises a processor; and a memory storing computer program codes; the memory and the computer program codes configured to, with the processor, cause the terminal device to perform the method for communication as above.

A network device comprises a processor; and a memory storing computer program codes; the memory and the computer program codes configured to, with the processor, cause the network device to perform the method for communication as above.

A computer readable medium having instructions stored thereon, the instructions, when executed by a processor of an apparatus, causing the apparatus to perform the method for communication as above.

The components included in the apparatuses and/or devices of the present disclosure may be implemented in various manners, including software, hardware, firmware, or any combination thereof. In one embodiment, one or more units may be implemented using software and/or firmware, for example, machine-executable instructions stored on the storage medium. In addition to or instead of machine-executable instructions, parts or all of the units in the apparatuses and/or devices may be implemented, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), and the like.

1-23. (canceled)

24. A method performed by a User Equipment (UE) comprising:
receiving a RRC message including information indicating whether a Packet Data Unit (PDU) Set Importance-based Service Data Unit (SDU) discard is configured; and
determining whether to perform the PDU Set Importance-based SDU discard, based on the information.

25. The method according to claim 24, further comprising:
performing the PDU Set Importance-based packet discard in a case where the information indicates that the PDU Set Importance-based SDU discard is configured.

26. The method according to claim 24, further comprising:
wherein the information indicates whether the PDU Set Importance-based SDU discard is configured for a data radio bearer (DRB).

27. A User Equipment (UE) comprising:
at least one memory configured to store instructions; and
at least one hardware processor coupled to the at least one memory,
wherein the at least one hardware processor is configured to:
receive a RRC message including information indicating whether a Packet Data Unit (PDU) Set Importance-based Service Data Unit (SDU) discard is configured; and
determine whether to perform the PDU Set Importance-based SDU discard, based on the information.
